(19) United States
(12) Patent Application Publication
(10) Pub. No.: US 2001/0021762 A1
(43) Pub. Date: Sep. 13, 2001

(54) Binder composition for a magnetic recording medium

(76) Inventors: Ulrike Hees, Mannheim (DE); Benedikt Raether, Limburgerhof (DE); Albert Kohl, Laumersheim (DE); Ria Kress, Ludwigshafen (DE); Rainer Blum, Ludwigshafen (DE)

Correspondence Address: Messrs Keil & Weinkauf, 1101 Connecticut Ave., N.W., Washington, DC, 20036, US

(21) Appl. No.: 09/777,851

(22) Filed: Feb. 7, 2001

(30) Foreign Application Priority Data
Feb. 9, 2000 (DE) 100 05 649.0

(51) Int. Cl. C08G 18/00

(52) U.S. Cl. 528/44

(57) ABSTRACT

A binder composition for a magnetic recording medium comprises at least one polyurethane having a structural unit according to the formula I

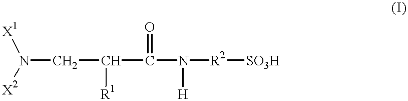

or a salt thereof, and a magnetic or magnetizable pigment.

The present invention relates to a binder composition, containing a polyurethane having a structural unit according to the formula I

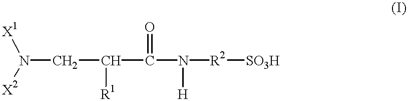

where R¹ is H or a linear or branched, saturated or unsaturated aliphatic hydrocarbon radical of 1 to 20 carbon atoms, a saturated or unsaturated, unsubstituted or substituted cycloaliphatic hydrocarbon radical of 4 to 20 carbon atoms or an unsubstituted or substituted araliphatic hydrocarbon radical of 6 to 40 carbon atoms, R² is a linear or branched, saturated or unsaturated aliphatic hydrocarbon radical of 1 to 20 carbon atoms or a cycloaliphatic hydrocarbon radical of 4 to 20 carbon atoms or an unsubstituted or substituted aromatic hydrocarbon radical of 6 to 18 carbon atoms, X¹ and X², in each case independently of one another, are an unsubstituted or substituted radical comprising at least two carbon atoms, at least one of the radicals X¹ and X² being incorporated into the polyurethane by reaction of an OH, NH₂, NHR² or SH group, or a salt thereof, and at least one magnetic or magnetizable pigment.

Magnetic recording media cover a wide range for the purposes of permanent storage of information. Usually, a magnetic recording medium consists of a nonmagnetic substrate material and at least one magnetizable layer bonded thereto and based on polymeric binders and magnetic pigments dispersed therein. Owing to the constantly increasing requirement for information storage and the associated increase in information density on a specific storage medium, magnetic recording media are having to meet higher and higher requirements with respect to quality of the recording and the reproduction as well as the aging resistance. In order to meet these requirements, the polymeric binder in which the magnetic pigments are dispersed is becoming increasingly important. Attempts are being made to improve the stability of the magnetic dispersion, to avoid the formation of defects on the magnetic layer and to improve the magnetic properties, in particular the residual induction, and to achieve higher packing densities of the magnetic pigments in the magnetic layer, which is achievable, for example, by reduction in the binder content in combination with an increase in the pigment content in this layer.

However, said measures complicate both the dispersion of the pigments in the dispersing process and the achievement of good dispersion stability. In addition, the magnetic layers must be very flexible, must have high resilience and must possess high tensile strength. Moreover, a reduction in the coefficients of friction and an increase in the abrasion resistance and wear resistance of the magnetic layer are increasingly being required in order to avoid drops in output level. These mechanical properties must also be ensured at high temperature and high atmospheric humidity.

However, many binders known to date from the prior art are not able to meet these requirements. In many cases, the wetting and dispersing of the pigments, in particular in the case of very finely divided magnetic pigments, are adversely affected. Any sintered material is not sufficiently dispersed in the dispersing process or reagglomeration of the pigment particles is not adequately prevented, which leads to poor magnetic properties of the recording medium. For this reason, relatively small amounts of low molecular weight dispersants were frequently added to the dispersion in the past in order to facilitate the dispersing process. However, such low molecular weight dispersants have disadvantages. For example, low molecular weight dispersants may easily be exuded under unfavorable climatic conditions, such as high atmospheric humidity and/or temperature, resulting in deposits on all tape-conveying parts, in particular on the head, in recording or playback apparatuses. Moreover, such deposits increase the friction, with the result that the magnetic recording medium may block during passage through a read or write apparatus.

In addition, the use of such dispersants can lead to compatibility problems in the dispersion. Since the dispersants have polar groups, the hydrophilic character of the layer increases greatly, which, in the case of humidity or high temperature, can result in swelling of the layer, exudation of the dispersants and lubricants and other mechanical changes. In order to improve the dispersing properties of polyurethane binders, was therefore proposed, for example, to incorporate polar groups into such a binder. For example, EP-A 0 193 084 discloses the incorporation of diols which carry additional polar groups into polyurethanes. Although such binders disperse the pigments very well, they lead, particularly in the case of pigments having a high BET value, to dispersions having extremely disadvantageous rheological properties, such as a high flow limit and high viscosity. This substantially complicates the processing and the casting of such dispersions to give magnetic layers.

Frequently, the lack of good dispersing properties of binders carrying ionic groups is also ascribed to the fact that the ionic groups do not have sufficient flexibility with respect to decoupling from the main chain, which adversely affects the dispersing properties of such a binder.

For example, U.S. Pat. No. 5,695,884 describes a thermoplastic polyurethane which has at least one sulfonate group. The sulfonate group is introduced into the polyurethane via a sulfonate-containing polyesterpolyol, which in turn contains the sulfonate group as a sulfophthalic acid derivative. In such polyurethanes, the fact that the sulfonate group has only restricted mobility owing to its bonding to the rigid phthalic acid moiety can be problematic, frequently having an adverse effect on the dispersing properties of the corresponding polyurethane. Moreover, such sulfonate groups are present directly in the main chain after incorporation into the polyurethane, with the result that flexibility and mobility may also be restricted.

Furthermore, the content of ionic groups having dispersing activity in such binders is generally restricted to a specific upper limit, since otherwise certain adverse effects occur which reduce the quality of the binder. Said adverse effects may include, for example, the occurrence of bridging flocculation and a dramatic increase in the hydrophilic character of the binder, which may be manifested in greater sensitivity to atmospheric humidity and swelling of the binder in a humid environment.

Frequently, the introduction of ionic groups into polyurethane binders is also problematic because the starting materials used in the preparation of polyurethane binders are often soluble only in water or aqueous solvent mixtures. However, such polyurethane binders prepared in an aqueous environment either have a residual water content undesired in the preparation of magnetic recording media or have to be freed from water present in the polyurethane binder by expensive methods.

The introduction of ionic groups into polyurethane binders is disclosed, for example, in DE-A 40 39 749. Here, it is stated that a branched polyurethane soluble in ethers or ketones and having OH-free urea groups at the chain ends and a molecular weight of from 30 000 to 200 000 is suitable as a binder in magnetic recording media. However, what is problematic in the case of this binder is that the compounds described therein may have no block structures.

DE-C 34 07 563 describes the introduction of sulfo groups into polyadducts or polycondensates. Here, a terminally unsaturated diol carrying two OH groups is converted into a terminal sulfonate by the bisulfite addition reaction. The sulfonate is then integrated, for example, into a polyurethane via the two OH groups. In this way, it is possible to avoid the disadvantage that the sulfonate group is attached to a rigid skeleton directly on the main chain, but the method described and the compounds obtainable thereby likewise have a number of disadvantages. For example, the fact that the bisulfite addition reaction takes place in an aqueous environment is disadvantageous. If a relatively hydrophobic diol is used in this environment for the bisulfite addition reaction, the reaction product is generally difficult to isolate. In such reactions, hydrophilic compounds are therefore usually used, for example the polyethers described in the publication. Although such sulfonated polyethers can subsequently be incorporated into polymeric compounds, on the one hand they do not help to make the main chain flexible and, on the other hand, owing to the reaction conditions in the synthesis, they enable the hydrophilic character of the sulfonate-carrying side chain to be varied only within narrow limits.

DE-B 19 54 090 describes a process for the preparation of 2-(amino-propionamido)alkanesulfonic acid salts and their use as anionic components in the preparation of polyurethane dispersions. The disadvantage in the case of the substances described there is that incorporation into a polyurethane is possible only via an amino group. However, the resulting polyureas have a number of properties which are disadvantageous when they are used for dispersing solids in a plastics matrix. In addition, the compounds described can be processed only in the aqueous phase. This is a serious disadvantage particularly when it is important that the corresponding compounds be free of water.

There was therefore a need for binder compositions for magnetic recording media which are simple to prepare, have excellent dispersion properties, are as far as possible anhydrous and permit simple control of the physical properties of the recording medium by specific chemical modifications.

It is an object of the present invention to provide binder compositions for the preparation of such magnetic recording media, and such magnetic recording media themselves.

We have found that this object is achieved by a binder composition which contains at least one polyurethane having a structural unit according to the formula I

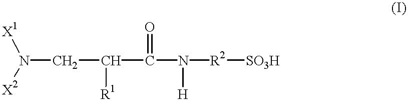

or a salt thereof.

The present invention therefore relates to a binder composition which contains at least one polyurethane having a structural unit according to the formula I

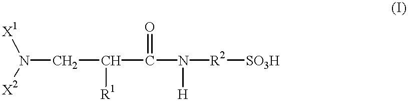

where R¹ is H or a linear or branched, saturated or unsaturated aliphatic hydrocarbon radical of 1 to 20 carbon atoms, a saturated or unsaturated, unsubstituted or substituted cycloaliphatic hydrocarbon radical of 4 to 20 carbon atoms or an unsubstituted or substituted araliphatic hydrocarbon radical of 6 to 40 carbon atoms, R² is a linear or branched, saturated or unsaturated aliphatic hydrocarbon radical of 1 to 20 carbon atoms or a cycloaliphatic hydrocarbon radical of 4 to 20 carbon atoms or an unsubstituted or substituted aromatic hydrocarbon radical of 6 to 18 carbon atoms, X¹ and X², in each case independently of one another, are an unsubstituted or substituted radical comprising at least two carbon atoms, at least one of the radicals X¹ and X² being incorporated into the polyurethane by reaction of an OH, NH₂, NHR² or SH group, or a salt thereof, and at least one magnetic or magnetizable pigment.

In the context of the present invention, a binder composition is understood as meaning a mixture which contains at least one polyurethane having a structural unit according to the formula I as a binder and at least one magnetic or magnetizable pigment.

In the context of the present invention, a binder is understood as meaning a polymer or a mixture of two or more polymers which, after chemical or physical drying, play an important role in producing stable magnetic dispersions and in sufficient mechanical stability of a magnetic recording medium prepared from the binder.

The incorporation of the structural units of the formula I into the polyurethane is effected, as described in detail further below, by reacting an appropriately functionalized sulfonic acid compound, or a mixture of two or more thereof, with a corresponding compound carrying at least two isocyanate groups (NCO groups), a polyaddition reaction taking place to give the polyurethane.

In the context of the present text, a sulfonic acid compound is understood as meaning a compound according to the formula II

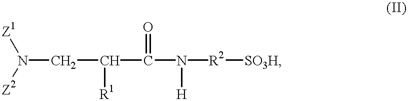

or a salt thereof, where R¹ and R² have the abovementioned meanings and Z¹ and Z², in each case independently of one another, are an unsubstituted or substituted radical comprising at least two carbon atoms, at least one of the radicals Z¹ and Z² having an OH, NH₂, NHR² or SH group.

Salts are understood as meaning, for example, the reaction products of the sulfo-carrying structural units with bases, it being possible for the bases to be both inorganic and organic. In the context of the present invention, both those sulfo-carrying structural units of the formula I which are already present as a salt prior to incorporation into a polyurethane and those which were converted into the salt form after incorporation into the polyurethane are suitable. Examples of corresponding salts are the salts of the alkali metals, such as lithium, sodium, potassium, rubidium or cesium, or the salts of the alkaline earth metals, such as magnesium, calcium or strontium. In addition to said salts with inorganic compounds, salts of the abovementioned sulfonic acids with organic compounds are however also suitable in the context of the present invention. In a preferred embodiment of the present invention, the salts of the abovementioned sulfonic acids are understood as meaning salts with amino compounds. Particularly suitable amino compounds are trialkylamines or hydroxyalkylamines, such as ethanolamine or diethanolamine, the corresponding alkyl radicals, independently of one another, being of 1 to about 22 carbon atoms. In a further preferred embodiment, the present invention relates to salts of the abovementioned sulfonic acids with trialkylamines whose alkyl radicals, independently of one another, are of 1 to about 5 carbon atoms.

The molecular weights stated in this text have the unit g/mol, unless stated otherwise. Molecular weights of compounds which have a random molecular weight distribution were determined by GPC. Here, the following materials were used:

Column material: PL-Gel 5 μm 2×500 Å. 1×1000 1×10 000

Eluent: THF 1 ml/min

Pump: Waters Type 510

Autosampler: Waters Type 717

UV detector: Waters Lambda—Max 481

RI detector: Waters Type 410

In the context of the present invention, R¹ is H or a linear or branched, saturated or unsaturated aliphatic hydrocarbon radical of 1 to about 20 carbon atoms, a saturated or unsaturated, unsubstituted or substituted cycloaliphatic hydrocarbon radical of 4 to about 20 carbon atoms or an unsubstituted or substituted araliphatic hydrocarbon radical of 6 to about 40 carbon atoms. In the stated ranges, R¹ may be chosen so that the claimed sulfonic acid compound conforms, for example, to a specific solubility profile, for example in connection with its preparation or its subsequent use, or can be tailored to a corresponding application with respect to another property dependent on the presence of specific alkyl chains in the molecule. In a preferred embodiment of the present invention, R¹ is hydrogen or a linear or branched, saturated hydrocarbon radical of 1 to about 16, in particular 1 to 6, carbon atoms. In a particularly preferred embodiment of the invention, R¹ is hydrogen or CH₃.

In the context of the present invention, R² is a linear or branched, saturated or unsaturated aliphatic hydrocarbon radical of 1 to 20 carbon atoms or a cycloaliphatic hydrocarbon radical of 4 to 20 carbon atoms or an unsubstituted or substituted aromatic hydrocarbon of 6 to 18 carbon atoms. In addition to the effect on the solubility parameters, described above in the statements with respect to the radical R¹, a change of radical R² can also be utilized, for the purposes of the present invention, to vary the flexibility and the spacing of the sulfo group from the remainder of the molecule, in particular in the case of the incorporation of the novel sulfonic acid compounds into a polymer. In a preferred embodiment of the invention, R² is a linear or branched aliphatic hydrocarbon radical of 3 to 8 carbon atoms.

In the context of the present invention, X¹ and X² in the formula I each have at least two carbon atoms. The number of carbon atoms is not necessarily based on carbon atoms covalently bonded to one another in a chain; rather, the present invention also comprises those sulfonic acid compounds whose radicals X¹ and X² each comprise at least two carbon atoms which are not bonded to one another directly covalently but, for example, by a further atom, such as O or N.

In the context of the present invention, X¹ and X² altogether have at least one covalent bond to a polyurethane via an OH, NH₂, NHR² or SH group. In a preferred embodiment of the present invention, the number of such bonds may be, for example, from 1 to about 8, in particular from 1 to about 4. In a further preferred embodiment of the invention, the number of bonds to a polyurethane in X¹ and X² is together 2 or 3. The abovementioned bonds may exist only via one of the two radicals X¹ or X², but it is also possible for incorporation into the polyurethane to take place via both radicals X¹ and X². In a preferred embodiment of the invention, each of the radicals X¹ and X² has at least one covalent bond to the polyurethane via an OH, NH₂, NHR₂ or SH group. In a further preferred embodiment of the invention, each of the two radicals X¹ and X² has one covalent bond to the polyurethane via an OH group.

In a preferred embodiment of the invention, the two radicals X¹ and X², independently of one another, are R³—Q—, R³—Q—(Y—O—)ₘY—Q— or R³O—T—Q—, where Q is O, NH, NR³ or S, R³ is linear or branched, saturated or unsaturated, unsubstituted or aromatically substituted alkyl of 2 to 44 carbon atoms, Y is alkyl of 2 to 10 carbon atoms, T is a polymer obtainable by polymerization, polyaddition or polycondensation and having a molecular weight M_{w} of from 150 to 5000 and m is from 1 to 300.

In the context of the present invention, a polymer obtainable by polymerization, polyaddition or polycondensation and having a molecular weight M_{w} of from 150 to 5000 is, for example, a polyester, polyether, polyamide, polyurethane, polycarbonate, polylactone, appropriately functionalized polyacrylate or polymethacrylate, polyvinyl acetate, polyvinyl alcohol, polyethyleneimine, polyvinylpyrrolidone, polyacrylonitrile, polyacrylamide, polyvinylamide or polyvinylamine.

In a further preferred embodiment of the invention, R³ is linear or branched, saturated, unsubstituted or aromatically substituted alkyl of 2 to about 10, particularly 3 to about 8, carbon atoms.

If X¹ or X² is R³—Q—(Y—O—)₃Y—Q—, then Y in a preferred embodiment of the invention is saturated, linear or branched alkyl of 2 to 4, in particular 2 or 3, carbon atoms or aromatically substituted, linear or branched alkyl having a total of 8 to about 18 carbon atoms. X¹ or X², or both, are then a polyether chain whose molecular weight M_{w} is dependent on the one hand on Y, but mainly on the value of m. In a preferred embodiment of the invention, m is from 1 to about 200, in particular from about 3 to about 50. If m is greater than 1, Y may be different alkyl radicals whose number of carbon atoms is in the abovementioned range. In the case of higher values of m, for example from about 5 to about 100, the various alkyl radicals Y may be arranged randomly or one after the other in any desired block sequence. m need not necessarily be an integer but may equally well assume any desired value between two integers in the abovementioned range. If m assumes a nonintegral value, m has an average value as occurs in conventional polyether syntheses owing to the random distribution of molecular weights in the polyaddition. In a further preferred embodiment of the invention, Y is CH₂—CH₂ or CH(CH₃)—CH₂ or CH₂—CH(CH₃) or a random or block sequence of these radicals.

Polyethers of the abovementioned type can be obtained, for example, by polymerization of ethylene oxide, propylene oxide, butylene oxide, tetrahydrofuran, styrene oxide or epichlorohydrin with itself, for example in the presence of basic catalysts, such as sodium methylate, potassium methylate, sodium ethylate, potassium ethylate, sodium hydroxide, potassium hydroxide or BF₃, or by an addition reaction of said compounds, if required as a mixture or in succession, with initiator components having reactive hydrogen atoms, such as alcohols or amines, e.g. water, diethylene glycol, 1,2-propanediol, 1,3-propanediol, 1,2-bis(4-hydroxydiphenyl)propane or aniline.

In a further preferred embodiment of the present invention, X¹ or X² is, or both are, R³—O—T—Q—. T therein is a polyester, a polyamide, a polycarbonate, a polyurethane or a polylactone having a molecular weight M_{w} of from about 200 to about 5000. In a further preferred embodiment of the invention, said polymers are linear polymers.

In a further preferred embodiment of the present invention, R³ is linear or branched, saturated alkyl of 2 to about 6 carbon atoms.

Suitable polyester can be obtained, for example, by polycondensation of linear or branched, aliphatic or cycloaliphatic, saturated or unsaturated diols with linear or branched, saturated or unsaturated, aliphatic or cycloaliphatic dicarboxylic acids or with aromatic dicarboxylic acids. Suitable diols are, for example, ethylene glycol, 1,2-propanediol, 1,3-propanediol, 1,3-butanediol, 1,4-butanediol, 1,4-butenediol, 1,4-butynediol, 1,5-pentanediol, neopentylglycol, bis(hydroxymethyl)cyclohexanes, such as 1,4is(hydroxymethyl)cyclohexane, 2-methylpropane-1,3-diol, methylpentanediols, diethylene glycol, triethylene glycol, tetraethylene glycol, dipropylene glycol, dibutylene glycol and further higher oligomers of said glycols, mixed oligomers also being suitable. In the context of the present invention, polyesters which were prepared using alcohols of the formula HO—(CH₂)ₖ—OH, where k is from 2 to about 44, are preferred. Examples of such alcohols are ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol or 1,12-dodecanediol or mixtures of two or more thereof.

Suitable dicarboxylic acids are, for example, dicarboxylic acids of the formula HOOC—(CH₂)ⱼ—COOH, where j is from 1 to about 44, for example an even number from 2 to about 20. Examples of such dicarboxylic acids are glutaric acid, pimelic acid, suberic acid, sebacic acid, dodecanedioic acid, phthalic acid, isophthalic acid, adipic acid, succinic acid or tererephthalic acid. Also suitable as acids for the synthesis of the abovementioned polyesters are azelaic acid, maleic acid, fumaric acid or dimeric fatty acids, tetrahydrophthalic acid, hexahydrophthalic acid, tetrachlorophthalic acid, endomethylenetetrahydrophthalic acid, or mixtures of two or more thereof.

If required, minor amounts of polycarboxylic acids which have a functionality of more than two may be used. Examples of these are trimellitic acid or pyromellitic acid.

It may be advantageous in the preparation of the polyester polyols to use the abovementioned carboxylic acids in the form of corresponding acid derivatives, such as carboxylic anhydrides, for example phthalic anhydride, tetrahydrophthalic anhydride, hexahydrophthalic anhydride, tetrachlorophthalic anhydride, endomethylenetetrahydrophthalic anhydride, glutaric anhydride, maleic anhydride or mixtures of two or more thereof, carbonyl chlorides or carboxylic esters, or mixtures of two or more thereof.

In a preferred embodiment of the present invention, the polyesters used have a molecular weight of from about 150 to about 1500.

Polyamides suitable as radical T in the context of the present invention can be prepared, for example, by reacting the abovementioned dicarboxylic acids with corresponding diamines. Suitable diamines are, for example, those which have a molecular weight of from about 32 to about 200 g/mol and have at least two primary amino groups, 2 secondary amino groups or one primary and one secondary amino group.

Examples of these are diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or, if necessary in small amounts, diamines such as diethylenetriamine or 1,8-diamino-4-aminomethyloctane. Polyamides which may be used in the context of the present invention have a molecular weight of from about 100 to about 800 in a preferred embodiment.

Furthermore, diols for the synthesis of corresponding polymers suitable as radical T are polycarbonate polyols, as obtainable, for example, by reacting phosgene with an excess of the abovementioned polyols. In a preferred embodiment of the invention, the polycarbonate polyols have a molecular weight of from about 100 to about 3000, for example from about 200 to about 1500. In a further preferred embodiment of the invention, the polycarbonate polyols are polycarbonate diols.

Polyurethanes suitable for use as radical T are obtainable, for example, by reacting corresponding polyisocyanates with compounds at least difunctional with respect to isocyanates. Corresponding reactions and suitable polyurethanes obtainable therefrom are described further below in this text.

According to the invention, polylactones as obtainable by homo- or copolymerization of lactones, in the presence or absence of a suitable, difunctional initiator molecule, are furthermore suitable for use as radical T. Preferred lactones are those which are derived from compounds of the formula HO—(CH₂)ᵢ—COOH, where i is from 1 to about 44. Examples are ε-caprolactone, β-propiolactone, γ-butyrolactone or methyl-ε-caprolactone or mixtures of two or more thereof. Polylactones preferably used in the context of the present invention have a molecular weight of from about 100 to about 3000, in particular from about 200 to about 1500.

For the purposes of the present invention, it is not necessary for the two radicals X¹ and X² to be identical. Each of the two said radicals, independently of one another, may be a radical as defined above.

The sulfonic acid compounds according to the formula II which are required for incorporation into the abovementioned polyurethanes can be prepared in various ways according to the rules of organic chemistry. For example, it is possible to prepare the novel compounds by subjecting corresponding components A and B to a Michael addition reaction.

For this purpose, for example, a compound of the formula III

Z¹—NH—Z² (III),

where Z¹ and Z² are as defined above, is reacted with a compound of the formula IV

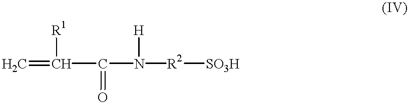

where R¹ and R² are as defined above.

Compounds of the formula III can be prepared according to the generally known principles of organic chemistry. The starting point for the preparation of such molecules is as a rule the compound NH(R²OH)₂, which, for example for the preparation of the abovementioned polyethers, is reacted with corresponding alkylene oxides, as described above. A molecule of the formula II can be obtained analogously by condensation reaction of this compound with correspondingly functionalized polyesters, polyamides, polycarbonates or polylactones.

Here, for the preparation of sulfonic acid compounds of the formula II, which are suitable for the preparation of polyurethanes of the abovementioned type, an amine of the formula III is therefore reacted with an ethylenically unsaturated amidosulfonic acid compound of the formula IV under suitable conditions.

The reaction can be carried out with or without a solvent. Suitable solvents are, for example, ethers, such as ethylene glycol dimethyl ether or tetrahydrofuran, ketones, such as acetone or methyl ethyl ketone, N-methylpyrrolidone, N,N-dimethylformamide, acetonitrile, trichloromethane or toluene, or mixtures of two or more thereof. If required, water may be present in the solvent mixture during the reactions in addition to the abovementioned solvents, in particular together with the abovementioned polar solvents. If the novel compounds are to be used for the preparation of essentially anhydrous polymers, then it is preferable for the purposes of the present invention to carry out the reaction in the absence of water. In this case, particularly preferred solvents are tetrahydrofuran, acetone or methyl ethyl ketone or a mixture of two or more thereof. The reaction temperature is from about 0 to about 200° C. Good results can be obtained, for example, in a temperature range from about 20 to about 90° C. The reaction can, if required, be accelerated by adding a basic catalyst. Suitable basic catalysts are, for example, triethylamine, pyridine, benzyltrimethylammonium hydroxide, sodium hydroxide or potassium hydroxide.

If required, a polymerization inhibitor may also be present in the reaction mixture during the reaction. Suitable polymerization inhibitors are, for example, hydroquinone monomethyl ether, stable radicals, such as the 2,2,6,6-tetramethylpiperidin-1-oxyl radical (TEMPO) or 2,2,6,6-tetramethyl-4-hydroxypiperidin-1-oxyl radical (TEMPOL), polymerization inhibitors from the group consisting of the sterically hindered amines (HALS) or from the group consisting of the nitroxides.

For the preparation of the novel binder composition, the sulfonic acid compounds of the formula II which are described above are incorporated into polyurethanes. In a preferred embodiment of the present invention, the polyurethanes are thermoplastic polyurethanes. In a further preferred embodiment of the invention, the thermoplastic polyurethanes, after incorporation of the structural units according to the formula I, are soluble in the abovementioned organic solvents, in particular in tetrahydrofuran, methyl ethyl ketone, N-methylpyrrolidone or N,N-dimethylformamide.

The polyurethanes which can be used in the novel binder composition can be prepared, for example, by reacting

A: a polyol having at least about 2 OH groups and a molecular weight of from about 500 to about 10 000, or a mixture of two or more thereof, and

B: a linear aliphatic diol having a molecular weight of less than 500, or a mixture of two or more thereof, and

C: a polyisocyanate of 6 to about 30 carbon atoms, or a mixture of two or more thereof, and

D: a compound according to the formula II or a salt thereof and, if required, a further compound having at least one ionic or ionizable group and at least about two groups reactive toward isocyanates, or a mixture of two or more thereof, and, if required,

E: a polyol having at least about 3 OH groups and 3 to about 10 carbon atoms, or a mixture of two or more thereof, and, if required,

F: an amino alcohol of 2 to about 16 carbon atoms, or a mixture of two or more thereof, or, if required, an amino compound which is at least difunctional with respect to isocyanates, or a mixture of two or more thereof.

Suitable components A are, for example, polyesterpolyols, polyetherpolyols, polycarbonatepolyols or polylactonepolyols having a molecular weight of from about 400 to about 10 000, for example from about 800 to about 5000. In a preferred embodiment of the present invention, the polyols used as component A have a molecular weight of from about 1000 to about 2500. Polyols particularly suitable in the context of the present invention are, for example, polyesterpolyols and polyetherpolyols which have from about 2 to about 3 OH groups per molecule. In a further preferred embodiment of the invention, the polyols used as component A carry from about 1.9 to about 2.1, in particular about 2, OH groups per molecule. In a preferred embodiment of the present invention, the acid number of the compounds used as component A is less than about 10, for example less than 8 or less than 5. In a further preferred embodiment of the invention, the acid number of the polyols used as component A is less than about 3.

Polyesters suitable for use as component A can be obtained, for example, by polycondensation of linear or branched, aliphatic or cycloaliphatic, saturated or unsaturated diols of 2 to about 20 carbon atoms with linear or branched, saturated or unsaturated, aliphatic or cycloaliphatic dicarboxylic acids or with aromatic dicarboxylic acids of 4 to about 15, for example about 4 to about 8, carbon atoms.

Suitable diols are, for example, ethylene glycol, 1,2-propanediol, 1,3-propanediol, 1,3-butanediol, 1,4-butanediol, 1,4-butenediol. 1,4-butynediol, 1,5-pentanediol, neopentylglycol, bis(hydroxymethyl)cyclohexanes, such as 1,4-bis(hydroxymethyl)cyclohexane, 2-methylpropane-1,3-diol, 2,2-dimethylpropane-1,3-diol, 2,2,4-trimethylpentane-1,5-diol, further methylpentanediols, diethylene glycol, triethylene glycol, tetraethylene glycol, dipropylene glycol, di-butylene glycol and further higher oligomers of said glycols, mixed oligomers also being suitable, dihydroxycyclohexane, 1,4-dimethylolcyclohexane, 1,4-diethanolcyclohexane, 2-methyl-2-butyl-1,3-propanediol, 2,2-dimethyl-1,4-butanediol, 1,4-dimethylolcyclohexane, neopentylglycol hydroxypivalate, methyldiethanolamine or aromatic-aliphatic or aromatic-cycloaliphatic diols of 8 to about 30 carbon atoms, it being possible for heterocyclic ring systems or preferably isocyclic ring systems, such as naphthalene derivatives or in particular benzene derivatives, such as bisphenol A to be used as aromatic structures, symmetrically diethoxylated bisphenol A, symmetrically dipropoxylated bisphenol A, more highly ethoxylated or propoxylated bisphenol A derivatives or bisphenol F derivatives, the hydrogenation products of said bisphenol A and bisphenol F derivatives or the products of the corresponding reaction of a compound, or a mixture of two or more of said compounds, with an alkylene oxide of two to about 8 carbon atoms, or a mixture of two or more such alkylene oxides.

Preferred polyesters in the context of the present invention are those which were prepared using alcohols of the formula HO—(CH₂)ₖ—OH. Examples of such alcohols are those mentioned above or mixtures of two or more thereof.

In a preferred embodiment of the invention, 1,2-ethanediol, 1,3-propanediol, 2-methyl-1,3-propanediol, 1,4-butanediol, 1,6-hexanediol, 2,2,-dimethyl-1,3-propanediol, 1,4-dimethylolcyclohexane, 1,4-diethanolcyclohexane and ethoxylated or propoxylated products of 2,2-bis(4-hydroxyphenylene)propane (bisphenol A) are used. Depending on the desired properties of the polyurethanes, said polyesterpolyols can be used alone or as a mixture of two or more of said polyesterpolyols in various ratios for the preparation of the polyurethanes.

Suitable dicarboxylic acids are, for example, dicarboxylic acids of the formula HOOC—(CH₂)ⱼ—COOH, as mentioned above. In a preferred embodiment of the present invention, polyesters used as component A are those which were prepared using adipic acid, succinic acid, phthalic acid or mixtures of two or more thereof.

In the preparation of the polyols suitable as component A, it may be advantageous to use the abovementioned carboxylic acids in the form of corresponding acid derivatives, as mentioned above.

Polyetherpolyols which are suitable for use as component A are essentially linear compounds which have terminal OH groups, contain ether bonds and have a molecular weight of from about 200 to about 8000, preferably from about 1000 to about 5000. Suitable polyetherpolyols can readily be prepared by polymerizing cyclic ethers, such as tetrahydrofuran, or by reacting one or more alkylene oxides having 2 to about 4 carbon atoms in the alkylene radical with an initiator molecule which has two active hydrogen atoms in the alkyl radical. Suitable alkylene oxides are, for example, ethylene oxide, 1,2-propylene oxide, epichlorohydrin or 1,2- or 2,3-butylene oxide. The corresponding alkylene oxides can be used individually, alternately in succession or as a mixture of two or more thereof. Suitable initiator molecules are, for example, the abovementioned diols. However, water, glycols, such as ethylene glycol, propylene glycol, 1,4-butanediol or 1,6-hexanediol, amines, such as ethylenediamine, hexamethylenediamine or 4,4′-diaminodiphenylmethane, or amino alcohols, such as diethanolamine, are particularly suitable. Said initiator molecules can be used alone or as a mixture of two or more thereof in the preparation of a polyetherpolyol suitable for use as component A. When they are used as component A, the polyetherpolyols described can be employed individually or as a mixture of two or more of said polyetherpolyols.

Polycarbonatepolyols suitable for use as component A are essentially linear and have on average at least two, preferably terminal, OH groups. Corresponding polycarbonatepolyols are prepared, for example, by reacting one of the abovementioned difunctional alcohols, or a mixture of two or more such difunctional alcohols, with phosgene. Suitable polycarbonatepolyols, for example those based on 1,6-hexanediol, and their preparation are described, for example, in U.S. Pat. No. 4,131,731.

Polylactones suitable for use as component A are obtainable, for example, by homo- or copolymerization of lactones, in the presence or absence of a suitable, difunctional initiator molecule. Preferred lactones are those which are derived from compounds of the formula HO—(CH₂)ᵢ—COOH, where z is from 1 to about 20. Examples are ε-caprolactone, β-propiolactone, γ-butyrolactone or methyl-ε-caprolactone, or mixtures of two or more thereof. Polylactones preferably used in the context of the present invention have a molecular weight of from about 400 to about 10 000, in particular from about 800 to about 8000, for example from about 1000 to about 5000.

In a preferred embodiment of the invention, for example, polyesters used as component A are those which are obtainable by reacting adipic acid or isophthalic acid or a mixture thereof with 1,6-hexanediol or cyclohexanedimethanol or a mixture thereof. Corresponding polyesterpolyols are sold, for example, under the name Lupraphen by BASF. Suitable types are, for example, Lupraphen AC 2000, Lupraphen ACI 1500, Lupraphen ACI 800, Lupraphen AC 1000, Lupraphen AC 800 or Lupraphen VP 9184. Suitable polycarbonates are sold, for example, under the name Desmorphen 2020 by Bayer.

In a preferred embodiment of the invention, compounds which have at least two functional groups reactive with respect to isocyanates with formation of a covalent bond are used as component B. In a preferred embodiment of the invention, difunctional alcohols as mentioned above in this text are used as component B. For example, these are diethylene glycol, 1,2-ethanediol, 1,3-propanediol, 2-methyl-1,3-propanediol, 1,4-butanediol, 1,5-pentanediol, 1,6-hexanediol, 1,7-heptanediol, 1,8-octanediol, 1,9-nonanediol, 1,10-decanediol and the corresponding higher homologs, as can be formed by stepwise extension of the carbon chain of said compounds, and, for example, 2,2,4-trimethylpentane-1,5-diol, 2,2-dimethylpropane-1,3-diol, 1,4-dimethylolcyclohexane, 1,4-diethanolcyclohexane, 2-methyl-2-butyl-1,3-propanediol, 2,2-dimethyl-1,4-butanediol, 1,4-dimethylolcyclohexane, neopentylglycol hydroxypivalate, diethylene glycol, triethylene glycol, methyldiethanolamine or aromatic-aliphatic or aromatic-cycloaliphatic diols of 8 to about 30 carbon atoms, it being possible to use heterocyclic ring systems or preferably isocyclic ring systems, such as naphthalene derivatives or in particular benzene derivatives, such as bisphenol A, as aromatic structures. In a preferred embodiment of the present invention, compounds which have a molecular weight of less than about 200, in particular less than about 150, g/mol are used as component B. Particularly suitable in this context are the low molecular weight aliphatic difunctional alcohols, for example ethylene glycol, propylene glycol, butylene glycol or neopentylglycol and similar short-chain aliphatic, linear or branched compounds.

In the context of the present invention, polyisocyanates which have on average at least about 2 isocyanate groups per molecule, preferably diisocyanates, are used as component C. In a preferred embodiment of the present invention, suitable diisocyanates have about 6 to about 30 carbon atoms. In a preferred embodiment of the invention, for example, linear aliphatic diisocyanates, such as tetramethylene 1,4-diisocyanate, pentamethylene 1,5-diisocyanate or hexamethylene 1,6-diisocyanate, aliphatic cyclic diisocyanates, such as cyclohexylene 1,4-diisocyanate, dicyclohexylmethane diisocyanate or isophorone diisocyanate (IPDI) are used. Other diisocyanates suitable in the context of the present invention are aromatic diisocyanates, such as toluene 2,4-diisocyanate (2,4-TDI), toluene 2,6-diisocyanate (2,6-TDI), the isomer mixture of the two last-mentioned diisocyanates, m-tetramethylxylylene diisocyanate (TMXDI), p-tetramethylxylylene diisocyanate, naphthylene 1,5-diisocyanate, tetrahydronaphthylene 1,5-diisocyanate, diphenylmethane 2,2′-diisocyanate, diphenylmethane 2,4′-diisocyanate and diphenylmethane 4,4′-diisocyanate and mixtures of two or more of said diisocyanates. In a preferred embodiment of the invention, diisocyanates which have an aromatic molecular component are used.

If required, isocyanates having a functionality of more than 2 can be used in minor amounts of up to about 5% by weight, based on the total amount of the diisocyanates used as component C. Isocyanates suitable for this purpose are, for example, the trimerization products of difunctional isocyanates, such as butylene 1,4-diisocyanate, pentamethylene 1,5-diisocyanate or hexamethylene 1,6-diisocyanate.

In the context of the present invention, at least the compounds of the formula II which are described above are used as component D. However, in the context of the present invention, it is possible, if required, to incorporate, in addition to the compounds of the formula II, further compounds which have one or more ionic or ionizable groups into the polyurethane. Suitable ionic or ionizable groups are the carboxyl groups, the phosphonic acid group and the sulfo group and salts thereof, or mixtures of 2 or more thereof, for example dimethylolpropionic acid.

In a preferred embodiment of the present invention, polyurethanes used in the preparation of the novel binder composition are those either whose content of ionic or ionizable groups are attributable exclusively to the use of a compound of the formula II or in whose preparation a compound of the formula II was used together with a suitable compound carrying one or more carboxyl groups, one or more sulfo groups or one or more phosphonic acid groups or salts thereof.

For example, the compounds described in DE-A 42 41 506 are suitable as corresponding compounds carrying phosphonic acid groups. Corresponding compounds carrying sulfo groups are described, for example, in DE-A 40 39 749.

Compounds of component E cause branching of the polyurethane molecules and are therefore used only in minor amounts in their preparation in the present invention. For example, aliphatic alcohols having three or more functional groups and 3 to about 15, preferably about 3 to about 10, carbon atoms can therefore be used in amounts of up to about 5% by weight, based on the total mass of the compounds of component B which are contained in the thermoplastic polyurethane, in the preparation of the polyurethanes. Suitable compounds are, for example, trimethylolpropane, triethylolpropane, glycerol, pentaerythritol, sorbitol, mannitol and further sugar alcohols having up to about 10 OH groups per molecule. The corresponding derivatives of said compounds, as can be prepared by reaction with an alkylene oxide of 2 to about 4 carbon atoms, or a mixture of two or more such alkylene oxides, can also be used for the preparation of the polyurethanes. Said compounds can be used alone in each case or as mixtures of two or more of said compounds.

If required, further, low molecular weight compounds may be present as component F in the reaction to give the polyurethanes which can be used in the novel binder compositions. Such compounds can act, for example, as chain extenders. For example, primary amino compounds of two to about 20, for example 2 to about 12, carbon atoms are suitable for this purpose. For example these are ethylamine, n-propylamine, isopropylamine, sec-propylamine, tert-butylamine, 1-aminoisobutane, substituted amines of two to about 20 carbon atoms, such as 2-(N,N-dimethylamino)-1-aminoethane, aminomercaptanes, such as 1-amino-2-mercaptoethane, aliphatic amino alcohols of 2 to about 20, preferably 2 to about 12, carbon atoms, for example ethanolamine, 1-amino-3,3-dimethylpentan-5-ol, 2-aminohexane, diethanol-amine, 1-amino-2,5-dimethylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentanemethanol or 2-amino-2-ethyl-1,3-propanediol, aromatic-aliphatic or aromatic-cycloaliphatic amino alcohols of 6 to about 20 carbon atoms, suitable aromatic structures being heterocyclic ring systems or preferably isocyclic ring systems, such as naphthalene or in particular benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol, and mixtures of two or more such compounds.

The reaction can be carried out in the presence or absence of a catalyst. In a preferred embodiment, said catalyst was, for example, a tertiary amine, such as triethylamine, tributylamine, diazabicyclo[2.2.2]octane, N-methylpyridine or N-methylmorpholine. Further suitable catalysts are organometallic compounds, such as dibutyltin dilaurate, and metal salts, such as tin octanoate, lead octanoate or zinc stearate. The amount of catalyst present during the reactions is in general from about 1 to about 400 ppm by weight.

In the preparation of the polyurethanes to be used in the novel binder composition, the components A to D and, if required, E or F or a mixture thereof can be reacted with one another in a conventional manner. The reaction can be carried out, for example, in a one-stage or in a multistage process. If the reaction is carried out in a one-stage process, the components desired in the reaction are initially taken simultaneously or in succession in a corresponding reaction vessel and the polyaddition reaction is then initiated. In a preferred embodiment of the invention, however, the corresponding polyurethanes are prepared in a multistage process, in particular in a 2-stage process. For carrying out the 2-stage process, all starting components A to D and, if required, E or F or a mixture thereof are dissolved in a part of the solvent so that solutions having a solids content of from about 15 to about 50% by weight are formed. The solutions are then heated to temperatures of from 20 to about 90° C., preferably from about 30 to about 70° C., while stirring, if necessary after the addition of a catalyst. The components are then reacted until the desired NCO content is reached.

Alternatively, it is also possible for component C to be initially taken in a little solvent and for the corresponding desired building blocks and, if required, the catalyst and the assistants and additives then to be added at from about 20 to about 90° C., preferably from about 30 to about 70° C., in the course of from about 0.2 to about 5 hours. The components are reacted until the desired NCO content is reached.

The presence of a solvent or diluent is generally not essential. In a preferred embodiment, however, a solvent or a mixture of two or more solvents is used. Suitable solvents are, for example, hydrocarbons, in particular toluene, xylene or cyclohexane, esters, in particular ethyl glycol acetate, ethyl acetate or butyl acetate, amides, in particular dimethylformamide or N-methylpyrrolidone, sulfoxides, in particular dimethyl sulfoxide, ethers, in particular diisopropyl ether or methyl tert-butyl ether, or preferably cyclic ethers, in particular tetrahydrofuran or dioxane.

In a preferred embodiment of the present invention, the novel binder composition contains, as a polyurethane, at least one thermoplastic block copolyurethane.

In the context of the present invention, a thermoplastic block polyurethane is understood as meaning a polyurethane which has at least one anchor group L and a block structure in which hard segments B and soft segments A alternate in the form . . . —A—B—A—B—A—. . . A thermoplastic block copolyurethane may have, for example, a structure A—B—A, where these individual blocks are present as separate microphases. The thermoplastic block copolyurethane has a softening point or a softening range at a specific temperature or within a specific temperature range. Above this softening point or softening range, the polyurethane is plastically deformable, said polyurethane retaining the form produced in the plastic state on returning temperatures below the softening point or softening range and behaving essentially like a thermosetting plastic.

In the context of the present invention, a hard segment (B) is understood as meaning a segment of a thermoplastic block copolyurethane molecule, the hard segment having a glass transition temperature above at least from about 20 to 40° C., preferably above at least about 50° C.

In the context of the present invention, a soft segment (A) is understood as meaning a segment of a polyurethane molecule which is covalently bonded to a hard segment and has a glass transition temperature of less than about 20° C.

The corresponding soft segments A and hard segments B carry, as described in detail in the following text, at least one anchor group L which originates from a structural element of the formula I. For the sake of clarity, however, the anchor groups L will not be shown in the following text, in particular in the formulae containing A and B.

In the context of the present invention, an anchor group L is understood in principle as meaning any functional group which is capable of interacting with ionic or nonionic, polar compounds. In particular, anchor groups are understood as meaning those functional groups which are capable of interacting with the surface of inorganic filler materials, in particular with the surface of inorganic magnetic or magnetizable pigments. According to the present invention, a thermoplastic block copolyurethane which can be used in a novel magnetic recording medium contains at least one sulfo group as an anchor group, which is present within a structural unit of the formula I.

For the sake of simplicity, the thermoplastic block copolyurethanes described in the present text will be referred to as thermoplastic polyurethanes or simply as polyurethanes in the following text. Polyurethanes which do not have thermoplastic properties or are not block copolymers are indicated expressly as such below.

The novel polyurethane may have anchor groups L either only in one soft segment or a plurality of soft segments A or only in a hard segment or in a plurality of hard segments B. In the context of the present invention, however, it is also possible to use thermoplastic polyurethanes which have anchor groups L both in one or more soft segments A and in one or more hard segments B. The number of anchor groups in the soft segment or in the soft segments A may be greater than the number of anchor groups in the hard segment or in the hard segments B; for example, the ratio of anchor groups in the soft segments A to the number of anchor groups in the hard segments B may be from about 1000:1 to about 100:1, or less, for example from about 10:1 to about 1.5:1. Conversely, the ratio of anchor groups in the hard segments B to the number of anchor groups in the soft segments A may likewise be from about 1000:1 to about 100:1, or less, for example from about 10:1 to about 1.5:1.

In a preferred embodiment of the invention, the number of anchor groups which are present in a hard segment of the thermoplastic polyurethane is greater than the number of anchor groups which are present in a soft segment (A) or a plurality of soft segments (A). In a preferred embodiment of the invention, the number of anchor groups which are present in the total number of hard segments (B) present in the polyurethane is at least five times greater, preferably at least 10 times greater, than the total number of anchor groups in the soft segments (A). In a further preferred embodiment of the invention, the novel thermoplastic polyurethane has essentially no anchor groups in the soft segment (A) or the soft segments (A).

According to the basic principle of the present invention, the magnetic recording medium contains at least one polyurethane which comprises a structural unit according to the formula I. Thermoplastic block copolyurethanes, as may be used in the context of the present invention, therefore contain at least one sulfo group as anchor group L. According to the statements made above, this sulfo group may be arranged both in a soft segment A and in a hard segment B. Moreover, a thermoplastic block copolyurethane which can be used in the novel magnetic recording medium may however also have further anchor groups which do not originate from a structural unit according to the formula I.

In a further embodiment of the invention, the novel polyurethane therefore contains, in addition to the abovementioned anchor group L, a carboxyl group, a sulfo group, a phosphonic acid group, a phosphoric acid group or a suitable salt of such a group or a quaternary amino group or primary, secondary or tertiary amino salt or two or more of the anchor groups mentioned in each case or a mixture of two or more of said anchor groups as a further anchor group L.

In a preferred embodiment of the present invention, the magnetic recording medium contains a thermoplastic polyurethane of the formula V

P—(A—B—A—)ₙP (V)

or a polyurethane of the formula VI

P—(A—B—A—V¹—)ₙ—A—B—A—P (VI)

where A and B have the abovementioned meanings, V¹ is a radical of a compound G—V—G at least difunctional with respect to P with formation of a covalent bond, after formation of a bond with P, P is a functional group reactive toward the functional groups G of the compound V with formation of a covalent bond, G is at least one functional group reactive toward the functional groups P with formation of a covalent bond, and n is from 1 to 10.

Such a thermoplastic block copolyurethane contains at least one type of soft segment A. In the context of the present invention, however, it is also possible for the thermoplastic polyurethane to contain two or more different types of soft segments A. The two or more different types of soft segments A may be, for example, chemically identical soft segments, i.e. soft segments which have an essentially identical chemical composition but which are different, for example, in the molecular weight. In the context of the present invention, however, it is also possible for two or more chemically different soft segments A to be used. Thus, a thermoplastic polyurethane used in a novel binder may have, for example, a polyester and a polyether as soft segments A.

For example, polyesters, polyethers, polyacetals, polycarbonates, polyesterethers and the like are in principle suitable as soft segments A.

Said compounds suitable for use as soft segments A have at least one functional group P. In a preferred embodiment of the invention, the compounds suitable as soft segments A have at least two functional groups P. In a further preferred embodiment of the invention, the functional groups P are attached as terminal groups to the compounds suitable for use as soft segment A.

In principle, P is a functional group which is capable of reacting with an NCO group with formation of a covalent bond. In a preferred embodiment of the invention, P is OH, NH₂, NHR³, SH or COOH, where R³ has the abovementioned meanings.

In a further preferred embodiment of the invention, P is an OH, NH₂ or NHR³ group, in particular an OH group. In the further course of the text, compounds suitable for the preparation of soft segments A will be described. For the sake of clarity, the compounds are described as OH-carrying compounds, unless stated otherwise. In the context of the present invention, it is however also possible to use corresponding compounds which carry, instead of the OH group stated in the further description, another functional group reactive toward NCO groups, for example one of the other functional groups stated for P, provided that a corresponding compound exists or can be prepared.

Polyesters suitable for the formation of soft segments are, for example, predominantly linear polymers having terminal OH groups, preferably those having two or three, in particular two, terminal OH groups. The polyesterpolyols can be prepared in a simple manner by esterifying linear or branched, saturated or unsaturated aliphatic or suitable aromatic dicarboxylic acids of 4 to about 15, preferably 4 to about 10, carbon atoms with glycols, preferably glycols of about 2 to about 25 carbon atoms, or by polymerizing lactones of about 3 to about 20 carbon atoms. Suitable dicarboxylic acids are, for example, the abovementioned dicarboxylic acids.

For the preparation of the polyesterpolyols, it may also be advantageous to use, instead of the dicarboxylic acids, corresponding acid derivatives, such as carboxylic anhydrides or carbonyl chlorides, if these are obtainable.

The polyester polyols which are suitable in the context of the present invention for use as a soft segment can be prepared by reacting dicarboxylic acids with corresponding glycols. Glycols suitable in principle for the preparation of the polyesterpolyols are linear or branched, saturated or unsaturated, aliphatic or aromatic glycols, as stated above in the present text.

In a preferred embodiment of the invention, the polyurethanes used are thermoplastic block copolyurethanes in whose preparation 1,2-ethanediol, 1,3-propanediol, 2-methyl-1,3-propanediol, 1,4-butanediol, 1,6-hexanediol, 2,2-dimethyl-1,3-propanediol, 1,4-dimethylolcyclohexane, 1,4-diethanolcyclohexane and ethoxylated or propoxylated products of 2,2-bis(4-hydroxyphenylene)propane (bisphenol A) were used in the soft segment A. Depending on the desired properties of the thermoplastic polyurethanes provided with the corresponding soft segments, said polyesterpolyols can be used alone or as a mixture of two or more of said polyesterpolyols in different ratios for the preparation of the thermoplastic polyurethanes. Suitable lactones for the preparation of the polyesterpolyols are, for example, α,α-dimethyl-γ-propiolactone, β-butyrolactone and ε-caprolactone.

Also suitable for use as soft segments A in the preparation of the abovementioned thermoplastic polyurethanes are the polyetherpolyols. Polyetherpolyols are understood as meaning essentially linear substances having terminal OH groups in the context of the above statements and having ether bonds. Suitable polyetherpolyols can be prepared, for example, by polymerization of cyclic ethers, such as tetrahydrofuran, or by reaction of one or more alkylene oxides having 2 to 4 carbon atoms in the alkylene radical with an initiator molecule which has two active hydrogen atoms. Suitable alkylene oxides are, for example, ethylene oxide, 1,2-propylene oxide, epichlorohydrin, 1,2-butylene oxide or 2,3-butylene oxide, or mixtures of two or more thereof.

The alkylene oxides can be used individually, alternately in succession or as mixtures of two or more of said alkylene oxides. Suitable initiator molecules are, for example, water, glycols, such as ethylene glycol, propylene glycol, 1,4-butanediol, 1,5-pentanediol and 1,6-hexanediol, amines, such as ethylene diamine, 1,6-hexamethylene diamine or 4,4′-diaminodiphenylmethane, and amino alcohols, such as methylethanolamine. In principle, however, all abovementioned at least difunctional compounds as have been described for the synthesis of the soft segments can be used as initiator molecules. Suitable polyesterpolyols and polyetherpolyols and their preparation are described, for example, in EP-B 0 416 386.

In the context of the present invention, for example, polycarbonates as mentioned above may also be used as soft segments A.

For example, aliphatic alcohols having three or more functional groups and 3 to about 15, preferably about 3 to about 10, carbon atoms can also be used in amounts of up to about 5% by weight, based on the total mass of the soft segments contained in the thermoplastic polyurethane, in the preparation of the soft segments. Suitable compounds have been mentioned above in the present text.

In a preferred embodiment of the invention, for example, polyesters which are obtainable from a reaction of adipic acid or isophthalic acid, or a mixture thereof, with 1,6-hexanediol or cyclohexanedimethanol, or a mixture thereof, are used as soft segment (A).

In a preferred embodiment of the invention, the soft segments (A) have glass transition temperatures of from about −50° C. to about 20° C. In a further preferred embodiment of the invention, the glass transition temperatures of the soft segments (A) are from about −30° C. to about 0° C. In order to ensure the desired mechanical properties of the novel thermoplastic polyurethane, the soft segment (A) should have a molecular weight of from about 500 to about 25 000 g/mol. In a preferred embodiment of the invention, soft segments (A) which have a molecular weight of from about 2000 to about 10 000, for example from about 3000 to about 7000, g/mol are used.

Compounds of the abovementioned classes of compounds which are suitable for use as soft segments (A) and already have a molecular weight range suitable for use as soft segment (A) may be present. However, it is also possible to use, for the preparation of soft segments (A), compounds of the abovementioned classes of compounds which have a molecular weight which is below the molecular weight suitable for use as soft segment (A) or below the desired molecular weight. In this case, it is possible, for the purposes of the present invention, to extend such compounds of the abovementioned classes of compounds by reaction with corresponding difunctional compounds until the required or desired molecular weight is reached. Depending on the terminal group P, for example, dicarboxylic acids, difunctional epoxy compounds or diisocyanates are suitable for this purpose, diisocyanates being used in a preferred embodiment of the present invention.

Compounds used in principle for the abovementioned molecular weight increase are those difunctional or polyfunctional compounds which lead to a glass transition temperature of the extended soft segment (A) which is in the desired range. In a preferred embodiment of the invention, diisocyanates, in particular those of 6 to about 30 carbon atoms for example, are therefore used in the stated case as compounds for increasing the molecular weight in the preparation of the soft segments (A), as stated above in this text. In a preferred embodiment of the invention, diisocyanates which have an aromatic molecular component are used.

The soft segments (A) may carry one or more anchor groups L. The soft segments (A) having anchor groups L are prepared according to the usual rules of organic chemistry, for example as described in the further course of the text in the context of the preparation of the hard segments (B) carrying anchor groups.

For the preparation of the hard segments B, diisocyanates are reacted with compounds which are difunctional with respect to isocyanate groups. The choice of diisocyanates and corresponding compounds difunctional with respect to isocyanate groups is made in such a way that the corresponding hard segment has a glass transition temperature as defined at the outset, the isocyanates stated above with regard to the soft segments once again being preferred.

If required, isocyanates having a functionality of more than 2 may be used in minor amounts of up to about 5% by weight, based on the total amount of the diisocyanates used for the preparation of the hard segment (B). Isocyanates suitable for this purpose are, for example, the trimerization products of difunctional isocyanates, such as butylene 1,4-diisocyanate, pentamethylene 1,5-diisocyanate or hexamethylene 1,6-diisocyanate.

Preferably used difunctional compounds for the preparation of the hard segments B are compounds which have at least two functional groups reactive toward isocyanates with formation of a covalent bond. Suitable functional groups are, for example, those stated above in the explanation of the functional groups P. In a preferred embodiment of the invention, difunctional alcohols as stated above are used for the preparation of the hard segments B. For example, these are diethylene glycol, 1,2-ethanediol, 1,3-propanediol, 2-methyl-1,3-propanediol, 1,4-butanediol, 1,5-pentanediol, 1,6-hexanediol, 1,7-heptanediol, 1,8-octanediol, 1,9-nonanediol, 1,10-decanediol and the corresponding higher homologs as can be formed by stepwise extension of the carbon chain of said compounds and, for example, 2,2,4-trimethylpentane-1,5-diol, 2,2-dimethyl-propane-1,3-diol, 1,4-dimethylolcyclohexane, 1,4-diethanolcyclohexane, 2-methyl-2-butyl-1,3-propanediol, 2,2-dimethyl-1,4-butanediol, 1,4-dimethylolcyclohexane, neopentylglycol hydroxypivalate, diethylene glycol, triethylene glycol, methyldiethanolamine or aromatic-aliphatic or aromatic-cycloaliphatic diols of 8 to about 30 carbon atoms, it being possible for heterocyclic ring systems or preferably isocyclic ring systems, such as naphthalene derivatives or in particular benzene derivatives, such as bisphenol A, to be used as aromatic structures. In a preferred embodiment of the present invention, compounds which have a molecular weight of less than about 200, particularly less than about 150, g/mol are used for the preparation of the hard segments B. Particularly useful in this context are the low molecular weight aliphatic difunctional alcohols, for example ethylene glycol, propylene glycol, butylene glycol, neopentyl glycol, neodiol (2-butyl-2-ethyl-1,3-propanediol) and similar short-chain aliphatic, linear or branched compounds.

One possibility for providing the thermoplastic block copolyurethanes with anchor groups L is to use a compound of the formula II in the synthesis of the thermoplastic polyurethane itself and thus to incorporate said compound into the thermoplastic polyurethane during the synthesis of the thermoplastic polyurethane.

However, further compounds which are likewise suitable for the incorporation of anchor groups L may also be incorporated into the thermoplastic polyurethane during this reaction. Such compounds have at least two functional groups reactive toward an isocyanate group with formation of a covalent bond, for example the abovementioned functional groups P. Suitable compounds are, for example, dimethylolpropionic acid or further difunctional compounds reactive with isocyanates and having a group, such as —SO₃Na, which interacts with inorganic surfaces, for example pigment surfaces, for example the Tegomer DS3135 previously sold by Goldschmidt.

The number of anchor groups L per segment (soft segment B or hard segment A) may vary within wide limits.

Depending on the conditions in the polymer synthesis, the parameter n need not necessarily be an integer since, as a rule, molecules having different molecular weights form during polymer syntheses and hence the number n may be different for molecules formed during the polymer synthesis. In the present case, the parameter n therefore expresses the average number of repeating units in the total population of the polymer molecules considered.

In a preferred embodiment of the invention, the hard segments (B) have glass transition temperatures which are more than the temperature of use of a magnetic storage medium produced with a novel binder composition, for example from about 20 to about 90° C. In a further preferred embodiment of the invention, the glass transition temperatures of the hard segments (B) are from about 30 to about 80° C., for example from about 40 to about 70° C. In order to ensure the desired mechanical properties of the novel thermoplastic polyurethane, the hard segments (B) should have a molecular weight of from about 350 to about 30 000 g/mol. In a preferred embodiment of the invention, hard segments (B) which have a molecular weight of from about 1000 to about 20 000, for example from about 2000 to about 15 000 or from about 3000 to about 12 000 g/mol are used.

The preparation of the soft segments (A) and of the hard segments (B) is carried out according to the usual rules of organic polymer chemistry. If the soft segment used is a polyester, a polyether, a polycarbonate, a polyacetal or another compound which can be used as a soft segment, its preparation is carried out by conventional methods of polymer chemistry which are known to a person skilled in the art. If different compounds from among said compounds which can be used as a soft segment are combined with one another because the molecular weight of the individual compounds is too low, this is done, depending on the difunctional compound used for the chain extension, likewise by the usual rules known in organic chemistry and applicable for the respective functional groups.

The preparation of the soft segments (A) is carried out so a to give a soft segment (A) which has two functional groups P, one group P being capable of reacting with an isocyanate group with formation of a covalent bond. Suitable groups P have been mentioned above in this text.

In a preferred embodiment of the invention, soft segments (A) which carry OH groups as functional groups P are used for the preparation of the thermoplastic polyurethanes. The number of functional groups P per soft segment should be at least about two. However, it is also possible to use soft segments whose functionality is higher than two, for example about 3. It is furthermore possible to use mixtures of two or more different soft segments (A) which differ, for example, in their functionality with respect to isocyanate groups. Thus, it is entirely possible for the purposes of the present invention for the soft segments (A) used to have a functionality with respect to isocyanate groups which is, for example, from 2 to 3, for example from about 2.1 to about 2.5.

In a preferred embodiment of the invention, the soft segments (A) used are polyesterpolyols, polyetherpolyols or polycarbonatepolyols which, if required, were extended with diisocyanates, for example diphenylmethane diisocyanate or toluene diisocyanate, in order to achieve a corresponding molecular weight.

The compounds used for the purposes of the present invention as hard segments (B) are prepared, in the context of a preferred embodiment, in such a way that polyurethane prepolymers which can be used as hard segments and have at least two isocyanate groups are present after the preparation. In a preferred embodiment of the invention, the compounds which can be used as hard segments have at least two isocyanate groups as terminal isocyanate groups.

The preparation of the novel thermoplastic polyurethanes is carried out by reacting the compounds which can be used as soft segments (A) with the compounds which can be used as hard segments (B). For the purposes of the present invention, compounds which can be used as soft segments (A) have a structure P—A—P, P having the abovementioned meanings and A being one of the structures which are described above and can be used as soft segment (A). Compounds which can be used for the purposes of the present invention as hard segments (B) accordingly have a structure OCN—B—NCO and are accordingly reactive with respect to the structures forming the soft segments, with formation of a covalent bond. Said structures represent only schematically the structure of the compounds to be reacted with one another. The number of functional groups may differ from the form shown structurally, according to the statements made above.

The reaction of the compounds P—A—P and OCN—B—NCO can be carried out in a manner known per se, preferably at from about 0 to about 120° C. The ratio of the two components is advantageously chosen so that the ratio of P to NCO groups is from about 2 to about 1. In accordance with the usual rules of polymer chemistry, the molecular weight of the thermoplastic polyurethanes obtained can be controlled within wide limit by varying said ratio.

At least one of the thermoplastic polyurethanes present in the novel binder has a molecular weight of from about 3000 to about 150 000, for example from about 5000 to about 100 000 or from about 8000 to about 50 000, for example from about 13 000 to about 35 000.

If required, further, low molecular weight compounds as mentioned above under component F may also be present in the reaction.

If required, the reaction can be carried out in the presence of a catalyst, as mentioned above.

The presence of a solvent or diluent is as a rule not necessary. In a preferred embodiment, however, a solvent or a mixture of two or more solvents is used. Suitable solvents are, for example, the abovementioned ones, in particular diisopropyl ether or methyl tert-butyl ether or preferably cyclic ethers, in particular tetrahydrofuran or dioxane.

If, in the preparation of the novel thermoplastic polyurethanes, the compound P—A—P is used in excess, for example in twice the molar amount, relative to the corresponding compound forming the hard segment, a thermoplastic polyurethane which carries functional groups P as terminal groups forms. For the preparation of thermoplastic polyurethanes, which have a structural element according to the formula II, these compounds containing terminal groups reactive toward isocyanate groups can be reacted, with chain extension, with compounds difunctional with respect to such groups. Corresponding difunctional compounds of the formula G—V—G have, as functional groups G, groups reactive toward the functional groups P. Examples of such functional groups G are primarily the isocyanate groups which are used in a preferred embodiment of the present invention. Depending on the type of functional group P, however, G may also be other functional groups reactive toward P, for example epoxy groups, carboxyl groups, carboxylic ester groups, carboxylic anhydrides or double bonds, which can be subjected to a Michael addition reaction with P.

In a preferred embodiment of the invention, V has, as functional groups G, at least two epoxy, OH, NCO or COOH groups or a mixture of two or more thereof which are not reactive with one another.

In a preferred embodiment, the novel binder composition contains at least one thermoplastic polyurethane. In a preferred embodiment of the present invention, the novel binder composition contains such a thermoplastic polyurethane, or a mixture of two or more such thermoplastic polyurethanes, in an amount of at least about 10, for example at least about 30, 50, 70 or 85, % by weight.

In a further preferred embodiment of the present invention, the novel binder composition also contains at least one further binder in addition to the abovementioned novel polyurethane or the abovementioned novel thermoplastic polyurethanes. The further polymers which can be used in the novel binder composition include, for example, polyacrylates, polyesterpolyurethanes, poly(meth)acrylateurethanes, polymethacrylates, polyacrylamides, polymers or copolymers of vinyl monomers, such as styrene, vinyl chloride, vinyl acetate, vinyl propionate, binders based on vinyl formals, cellulose-containing polymers, such as cellulose esters, in particular cellulose nitrates, cellulose acetates, cellulose acetopropionate or cellulose acetobutyrate, phenoxy resins or epoxy resins, as can be obtained in a manner known per se, or mixtures of two or more thereof.

The novel binder composition contains the polyurethanes described above as a rule in an amount of up to about 100% by weight, based on the total amount of polymers contained in the binder composition. Further polymers may be present in an amount of up to about 80, for example up to about 70, 60, 50, 40 or 30, % by weight or less.

In a further preferred embodiment of the invention, the binder contains about 50±10% by weight of novel polyurethane, it being possible for the remainder to consist of conventional polymers suitable for use in binders, for example polyurethanes.

The novel binder compositions may contain the abovementioned polyurethanes both as dispersing binders and as laking binders. If a novel binder composition contains a polyurethane as a dispersing binder, the number of anchor groups per soft or hard segment in the polymer should be at least about 1, in particular from about 1 to about 3. If a novel binder composition contains such a polyurethane as a laking binder, the number of anchor groups per soft or hard segment in the polymer should be from about 0.1 to less than 1, in particular from about 0.2 to about 0.6. The same applies if mixtures of two or more polyurethanes are used as dispersing or laking binders. In a preferred embodiment of the invention, the ratio of hard segments B having anchor groups to hard segments B without anchor groups should be established so that the abovementioned values are complied with.

In a preferred embodiment of the invention, polymers suitable for use as dispersing binders have a glass transition temperature (T_{g}) of from about 55 to about 65° C. and a molecular weight of from about 10 000 to about 25 000. In a preferred embodiment of the invention, polymers suitable as laking binders have a glass transition temperature (T_{g}) of from about 12 to about 30° C. and a molecular weight of from about 40 000 to about 80 000.

The novel binders contain a magnetic pigment, or a mixture of two or more magnetic pigments, in addition to the polymers described above, or a mixture of two or more such polymers. Suitable magnetic pigments are oxidic pigments, such as γ-Fe₂O₃, γ-Fe₃O₄, CrO₂, Co-modified FeOₓ (x=1.33-1.5), metallic pigments, such as Fe, Co and Ni or alloys thereof, barium ferrite or strontium ferrite.

Further elements or compounds may be mixed with these pigments, as is generally customary. As a rule, these pigments are anisotropic magnetic pigments.

For example, acicular or spindle-like cobalt-modified or unmodified γ-Fe₂O₃, γ-Fe₃O₄, CrO₂ or metallic pigments, such as Fe, Co and Ni or alloys thereof, are preferred. The particle size is in general from 0.04 to 2 μm and the ratio of mean longitudinal axis to mean transverse axis (aspect ratio) is from 2 to 20. In a preferred embodiment of the present invention, magnetic pigments whose particle size is from 0.07 to 0.8 μm and whose aspect ratio is from 2 to 20 are used. Metal pigments or their alloys and mixtures which also contain at least one further magnetic pigment in addition to metal pigments are particularly preferred.

Moreover, the novel binder compositions may also contain fillers, dispersants, further additives, such as lubricants, carbon black or nonmagnetic inorganic or organic pigments.

The lubricants used may be, for example, carboxylic acids of about 10 to about 20 carbon atoms, in particular stearic acid or palmitic acid, or derivatives of carboxylic acids, such as their salts, esters or amides, or mixtures of two or more thereof.

Examples of suitable nonmagnetic inorganic pigments are carbon black, graphite, metals, metal oxides, metal carbonates, metal sulfates, metal nitrides, metal carbides and metal sulfides. TiO₂ (rutile or anatase), TiOₓ, cerium oxide, tin oxide, tungsten oxide, antimony oxide, ZnO, ZrO₂, SiO₂, Cr₂O₃, α-Al₂O₃, β-Al₂O₃, γ-Al₂O₃, α-Fe₂O₃, goethite, corundum, silicon nitride, titanium carbide, magnesium oxide, boron nitride, molybdenum sulfide, copper oxide, MgCO₃, CaCO₃, BaCO₃, SrCO₃, BaSO₄, silicon carbide and titanium carbide may be mentioned by way of example. These compounds may be present either individually or in combination with one another and are not restricted in shape and size. The compounds need not be present in pure form but may have been surface-treated with other compounds. Organic fillers, such as polyethylene or polypropylene, may also be used.

The novel binder compositions can be obtained by mixing the abovementioned polymers with magnetic or magnetizable pigments. The present invention therefore also relates to a process for the preparation of a novel binder composition, in which a polyurethane having a structural unit according to the formula I

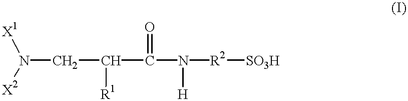

where R¹ is H or a linear or branched, saturated or unsaturated aliphatic hydrocarbon radical of 1 to 20 carbon atoms, a saturated or unsaturated, unsubstituted or substituted cycloaliphatic hydrocarbon radical of 4 to 20 carbon atoms or an unsubstituted or substituted araliphatic hydrocarbon radical of 6 to 40 carbon atoms, R² is a linear or branched, saturated or unsaturated aliphatic hydrocarbon radical of 1 to 20 carbon atoms or a cycloaliphatic hydrocarbon radical of 4 to 20 carbon atoms or an aromatic radical of 6-18 carbon atoms, X¹ and X², in each case independently of one another, are an unsubstituted or substituted radical comprising at least two carbon atoms, at least one of the radicals X¹ and X² being incorporated into the polyurethane by reaction of an OH, NH₂, NHR³ or SH group, or a salt thereof, is dispersed with at least one magnetic or magnetizable pigment.

For the preparation of the novel binder compositions, a polyurethane, or a mixture of two or more of the abovementioned polyurethanes, can therefore be dispersed together with a magnetic pigment, or a mixture of two or more magnetic pigments, for example as a mixture with one or more solvents and, if required, together with fillers, dispersants, further binders and further additives, such as lubricants, carbon black or nonmagnetic inorganic or organic pigments. In a preferred embodiment, the main components in the novel binder composition, i.e. in particular the pigments and the polymeric binders, are first mixed with addition of a little solvent to give a pasty mass and are then thoroughly mixed with one another, for example by kneading, and only thereafter are dispersed. Thus, the novel binder composition can then be prepared, for example in a dispersing apparatus, for example a tubular ball mill or a stirred ball mill, from the magnetic pigment and the further ingredients of the binder composition which have been converted into a paste or from a solution of the binders used, preferably in an organic solvent, with addition of lubricant and possibly small amounts of a dispersant.

When they are used for the production of magnetic recording media, the novel binder compositions can be applied, for example, to conventional rigid or flexible substrate materials whose thickness is in general from about 0.5 to about 200 μm. Suitable substrate materials are, in particular, films of linear polyesters, such as polyethylene terephthalate or polyethylene naphthalate, which for example have thicknesses of from about 4 to about 150 μm, for example from about 5 to about 36 μm.

The present invention also relates to a magnetic recording medium, at least containing a novel binder composition or a binder composition prepared according to a novel process.

The production of the novel magnetic recording media can be carried out in a known manner. Expediently, the binder composition prepared in a dispersing apparatus, for example a tubular ball mill or a stirred ball mill, from the magnetic pigment and a solution of the binder, preferably in an organic solvent, with addition of lubricant, possibly small amounts of dispersant and conventional further additives, and, if required, after admixing of a crosslinking agent, is filtered and is applied by means of the conventional coating apparatus, for example a knife coater or an extruder, to the nonmagnetic substrate. The coating can be effected on one or both sides of the substrate.

It is possible to apply the novel binder composition in a plurality of layers, it being possible for the type and/or amount of the magnetic or magnetizable pigments in the individual layers to be identical or different. It is also possible to apply an adhesion-promoting layer or one or more binder-containing layers which contain no magnetic or magnetizable pigments directly to the substrate. A layer structure in which layers which contain magnetic or magnetizable pigments alternate with layers without magnetic or magnetizable pigments is also possible. If a plurality of magnetic and/or nonmagnetic layers are applied, the production of magnetic recording media can be carried out both by the known wet-on-dry method and by the known wet-on-wet method. All apparatuses known from the prior art to be suitable may be used.

As a rule, magnetic orientation is carried out before the liquid binder composition is dried on the substrate. The latter is expediently effected in from about 10 to about 200 seconds at from about 50 to about 90° C. The magnetic layers can be calendered and compacted on conventional apparatuses by being passed between heated and polished rolls, if required with application of pressure and at from about 25 to about 100° C., preferably from 60 to about 90° C. It has proven to be very advantageous in the case of crosslinking binders to carry out the calendering before the crosslinking is complete, since the OH-carrying polymers are very thermoplastic in the uncrosslinked state without sticking. The thickness of the magnetic layer is in general from about 0.1 to about 20 μm, preferably from about 0.2 to about 8 μm.

In the case of the production of magnetic tapes, the coated films are slit in the longitudinal direction and into the conventional widths generally specified in inches; in the production of round recording media, the desired shape is punched out.

The present invention also relates to the use of a novel binder composition or of a binder composition prepared according to the invention for the production of magnetic recording media.

Magnetic recording media are to be understood as meaning all known rigid or flexible, analog or digital recording media, for example audio or video tapes, data tapes, floppy disks, magnetic cards or the like.

The present invention furthermore relates to a magnetic recording medium containing a novel binder composition or a binder composition prepared according to the invention.

In a preferred embodiment of the invention, the novel magnetic recording medium contains, as magnetic or magnetizable pigment, a ferromagnetic metal pigment or a ferromagnetic metal alloy pigment. In a further preferred embodiment of the invention, the binder composition contains at least one further magnetic or nonmagnetic pigment.

The novel magnetic recording medium can be used, for example, as a video tape, audio tape, data tape, floppy disk or magnetic card.

The Examples which follow illustrate the invention.

+

The Examples which follow illustrate the invention.

### EXAMPLE 1

Preparation of the Michael adduct of diisopropanolamine and 2-acrylamido-2-methylpropanesulfonic acid

In a stirred apparatus, 103.5 g (0.5 mol) of 2-acrylamido-2-methylpropanesulfonic acid and 0.5 g of 4-methoxyphenol were dissolved in 100 g of water. 20 g (0.5 mol) of sodium hydroxide in 60 g of water were then added dropwise at not more than 30° C. Thereafter, 59.85 g (0.45 mol) of diisopropanolamine in 60 g of water were added and the mixture was heated to 120° C. (external temperature). After a reaction time of 8 hours, the mixture was cooled to room temperature and was neutralized with 49.3 g (0.5 mol) of concentrated hydrochloric acid. Thereafter, the solvent was removed and the residue was dissolved in 53 g of warm ethanol. The sodium chloride precipitated was separated off. The product obtained was a brown, highly viscous liquid. The filtrate crystallized on cooling.

### EXAMPLE II

Preparation of a polyurethane from isophorone diisocyanate, 2-butyl-2-ethyl-1,3-propanediol and the Michael adduct of diisopropanolamine and 2-acrylamido-2-methylpropanesulfonic acid

17.0 g (0.05 mol) of the Michael adduct from Example 1 were reacted with 66.6 g (0.3 mol) of isophorone diisocyanate and 0.5 g of dibutyltin dilaurate in 130 g of N-methylpyrrolidone at 100° C. while stirring. At an NCO content of the solution of 9.83%, 48 g (0.3 mol) of 2-butyl-2-ethyl-1,3-propanediol and 0.1 g of dibutyltin dilaurate were added and the mixture was heated at 100° C. until the end of the reaction. After removal of the solvent, the product was soluble in tetrahydrofuran, toluene and methanol.

### EXAMPLE III

Preparation of a dispersing binder based on a Michael adduct

1 mol of the product from Example II was reacted with 12 mol of 2-butyl-2-ethyl-1,3-propanediol and 14 mol of diphenylmethane 4,4′-diisocyanate in 24 kg of tetrahydrofuran at 60° C. At an NCO content of the solution of 0.26%, a 24.6% strength solution of 2 mol of a polyurethane having a terminal OH group and a molecular weight of 4000, consisting of a polyester (adipic acid, isophthalic acid and cyclohexanedimethanol; molecular weight of about 800) and MDI, dissolved in tetrahydrofuran, was added. The further reaction was carried out at 60° C. The resulting product had a K value (according to Fikentscher) of 31 and a glass transition temperature, determined by means of DSC, of 75° C.

### EXAMPLE IV

A stirred ball mill having a capacity of 1.5 l and containing 2.7 kg of ceramic balls having a diameter of from 1.0 to 1.5 mm was filled with

4.2 kg of an organic solvent mixture consisting of 80% of THF and 20% of isobutyl methyl ketone;

930 g of a solution of a novel polymer, 15% strength in THF;

500.4 g of a solution of a commercial polyurethane having sulfonate anchor groups (from Morthane), 25% strength in THF;

1200 g of a ferromagnetic metal pigment (Hc=127 kA/m; SSA=58 m²/g; average particle size 71 nm, mean particle diameter 25 nm);

110 g of α-alumina (average particle diameter 320 nm);

12 g of carbon black (BET=60 m²/g; primary particle size 30 nm);

12 g of stearic acid;

9 g of fatty ester

and dispersing was carried out for 6 hours. The dispersion thus prepared was homogeneous, finely divided, stable to settling and flockulum-free. The dispersion was then filtered under pressure through a filter (pore size 3 μm) Immediately before application as coating, 42 g of a 50% strength solution of a reaction product of 3 mol of toluene 2,4-diisocyanate (TDI) and 1 mol of trimethylolpropane in THF were added to the dispersion with vigorous stirring.

The dispersion was applied, as a layer having a thickness of 2 μm when dry, to a polyethylene terephthalate film having a backing coating. Before drying, the coated web was passed through an orientation zone, consisting of a coil having a field strength of 200 kA/m, in order to orient the ferromagnetic pigments. After drying at 80° C., the film web was surface-treated in a steel/steel calender having 6 gaps at 85° C. and a pressure of 200 kg/cm and then slit into ½-inch-wide video tapes.

### COMPARATIVE EXAMPLE

The procedure was as described above, except that the novel polyurethane was replaced with an equivalent weight of a commercial VC copolymer having sulfonate anchor groups (from Nippon Zeon).

The measured results obtained are shown in Table 1:

TABLE 1

| | Example | Comparative Example |
|---|---|---|
| Duration of dispersing [h] | 9 | 11 |
| Gloss 1 | 123 | 110 |
| Gloss 2 | 122 | 105 |
| Surface defects | None | None |
| RF level (dB) | +1.0 | 0 |
| S/N (dB) | +0.6 | −0.4 |
| Abrasion on the video head | 2.5 | 4.0 |
| Coefficient of friction | 0.20 | 0.25 |
| (RAF test) | | |

The measured values in Table 1 have the following meanings:

Gloss measurement:

A reflection at an angle of 60° from the uncalendered layer was measured.

Gloss 1: Gloss immediately after drying the applied layer.

Gloss 2: Gloss after 24 hours on the roller stand.

The pigment dispersion is all the better the higher the gloss.

RF level:

The radio frequency level was measured in a Betacam SP recorder (system BVW 75, from Sony) against the reference tape Sony RSB 01 SP. The tape is all the better the higher the RF level.

S/N (luminance):

The luminance signal was measured in a Betacam SP recorder (system BVW 75, from Sony) against the reference tape Sony RSB 01 SP. The tape is all the better the higher the S/N value.

Coefficient of friction:

The coefficient of friction in the RAF test was determined for a sample length of 150 mm and a measuring distance of 100 mm. After conditioning for 15 minutes at 40° C. and 80% relative humidity, the piece of tape was drawn back and forth over a length of 100 mm with a force of 2 N and a speed of 20 m/s over a steel pin (diameter 2.5 mm, angle of wrap 90°). The coefficient of friction after 100 cycles under the abovementioned climatic conditions was measured. The running properties of the tape is all the better the lower the value.

We claim:

1. A binder composition, containing a polyurethane having a structural unit according to the formula I 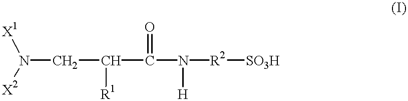
where R¹ is H or a linear or branched, saturated or unsaturated aliphatic hydrocarbon radical of 1 to 20 carbon atoms, a saturated or unsaturated, unsubstituted or substituted cycloaliphatic hydrocarbon radical of 4 to 20 carbon atoms or an unsubstituted or substituted araliphatic hydrocarbon radical of 6 to 40 carbon atoms, R² is a linear or branched, saturated or unsaturated aliphatic hydrocarbon radical of 1 to 20 carbon atoms or a cycloaliphatic hydrocarbon radical of 4 to 20 carbon atoms or an unsubstituted or substituted aromatic hydrocarbon radical of 6 to 18 carbon atoms, X¹ and X², in each case independently of one another, are an unsubstituted or substituted radical comprising at least two carbon atoms, at least one of the radicals X¹ and X² being incorporated into the polyurethane by reaction of an OH, NH₂, NHR³ or SH group, where R³ is linear or branched, saturated or unsaturated, unsubstituted or aromatically substituted alkyl of 1 to 44 carbon atoms, or a salt thereof, and at least one magnetic or magnetizable pigment.

2. A binder composition as claimed in claim 1, wherein the two radicals X¹ and X², independently of one another, are R²—Q—, R²—Q—(Y—O—)ₘY—Q— or R²—O—T—Q—, where Q is O, NH, NR³ or S, R³ is linear or branched, saturated or unsaturated, unsubstituted or aromatically substituted alkyl of 1 to 44 carbon atoms, Y is linear or branched, unsubstituted or aromatically substituted alkyl of 2 to 10 carbon atoms, T is a polymer obtainable by polymerization, polyaddition or polycondensation and having a molecular weight M_{w} of from 150 to 5000 and m is from 1 to 300 and R² has the meanings stated in claim 1.

3. A binder composition as claimed in claim 1 or 2, wherein Y is CH₂—CH₂ or CH(CH₃)—CH₂ or CH₂—CH(CH₃) or a random or block sequence of these radicals.

4. A binder composition as claimed in any of claims 1 to 3, wherein R² is linear or branched, saturated alkyl of 2 to 6 carbon atoms.

5. A binder composition as claimed in any of claims 1 to 4, wherein the polyurethane was prepared by reacting
A: a polyol having at least about 2 OH groups and a molecular weight of from about 500 to about 10 000, or a mixture of two or more thereof, and
B: a linear aliphatic diol having a molecular weight of less than 500, or a mixture of two or more thereof, and
C: a polyisocyanate of 6 to about 30 carbon atoms, or a mixture of two or more thereof, and
D: a compound according to the formula II 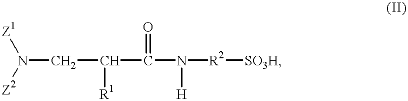
or a salt thereof, where R¹ and R² have the meanings stated in claim 1 and Z¹ and Z², in each case independently of one another, are an unsubstituted or substituted radical comprising at least two carbon atoms, at least one of the radicals Z¹ and Z² having an OH, NH₂, NHR³ or SH group, where R³ has the meanings stated in claim 2, and, if required, a further compound having at least one ionic or ionizable group and at least about two groups reactive toward isocyanates, or a mixture of two or more thereof, and, if required,
E: a polyol having at least about 3 OH groups and 3 to about 10 carbon atoms, or a mixture of two or more thereof, and, if required,
F: an amino alcohol of 2 to about 16 carbon atoms, or a mixture of two or more thereof, or, if required, an amino compound which is at least difunctional with respect to isocyanates, or a mixture of two or more thereof, or a mixture of two or more thereof.

6. A binder composition as claimed in any of claims 1 to 5, which contains at least one thermoplastic polyurethane.

7. A process for the preparation of a binder composition as claimed in any of claims 1 to 6, in which a polyurethane having a structural unit according to the formula I 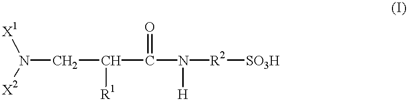
where R¹ is H or a linear or branched, saturated or unsaturated aliphatic hydrocarbon radical of 1 to 20 carbon atoms, a saturated or unsaturated, unsubstituted or substituted cycloaliphatic hydrocarbon radical of 4 to 20 carbon atoms or an unsubstituted or substituted araliphatic hydrocarbon radical of 6 to 40 carbon atoms, R² is a linear or branched, saturated or unsaturated aliphatic hydrocarbon radical of 1 to 20 carbon atoms or a cycloaliphatic hydrocarbon radical of 4 to 20 carbon atoms or an unsubstituted or substituted aromatic hydrocarbon radical of 6 to 18 carbon atoms, X¹ and X², in each case independently of one another, are an unsubstituted or substituted radical comprising at least two carbon atoms, at least one of the radicals X¹ and X² being incorporated into the polyurethane by reaction of an OH, NH₂, NHR³ or SH group, where R³ is linear or branched, saturated or unsaturated, unsubstituted or aromatically substituted alkyl of 1 to 44 carbon atoms, or a salt thereof, is mixed with at least one magnetic or magnetizable pigment.

8. The use of a binder composition as claimed in any of claims 1 to 6 or of a binder composition prepared as claimed in claim 7 for the preparation of magnetic recording media.

9. A magnetic recording medium containing a binder composition as claimed in any of claims 1 to 6 or prepared as claimed in claim 7.

10. A magnetic recording medium as claimed in claim 9, the magnetic or magnetizable pigment being a ferromagnetic metal pigment or a ferromagnetic metal alloy pigment.

11. A magnetic recording medium as claimed in either of claims 9 and 10, the binder composition containing at least one further magnetic or nonmagnetic pigment.

12. A magnetic recording medium as claimed in any of claims 9 to 11, which is a video tape, an audio tape, a data tape, a floppy disk or a magnetic card.
